(19) United States
(12) Patent Application Publication
(10) Pub. No.: US 2022/0080978 A1
(43) Pub. Date: Mar. 17, 2022

(54) INFORMATION PROCESSING DEVICE, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Takaharu UENO, Nagoya-shi (JP); Kenichi Yamada, Nisshin-shi (JP); Ryosuke Kobayashi, Nagakute-shi (JP); Shintaro Matsutani, Kariya-shi (JP)

(73) Assignee: TOYOTA JIDOSHA KABUSHIKI KAISHA, Toyota-shi (JP)

(21) Appl. No.: 17/468,037

(22) Filed: Sep. 7, 2021

(30) Foreign Application Priority Data
Sep. 11, 2020 (JP) 2020-152803

(51) Int. Cl. B60W 40/09; G01C 21/36

(52) U.S. Cl. CPC B60W 40/09; B60W 2540/30; G01C 21/3605

(57) ABSTRACT

An information processing device includes a control device configured to execute: acquisition of a content of a behavior of a user; determination of whether the behavior of the user satisfies a first condition indicating a sign of movement; and movement of a vehicle to a predetermined location where the user and the vehicle are scheduled to join when the behavior of the user satisfies the first condition. The control device executes, when the behavior of the user satisfies the first condition and satisfies a second condition indicating a suspicious behavior, control to obstruct realization of movement desired by the user for the vehicle.

### CROSS-REFERENCE TO RELATED APPLICATION

This application claims priority to Japanese Patent Application No. 2020-152803 filed on Sep. 11, 2020, incorporated herein by reference in its entirety.

### BACKGROUND

### 1. Technical Field

The present disclosure relates to an information processing device, an information processing system, and an information processing method.

### 2. Description of Related Art

A vehicle dispatch system that controls a vehicle so as to arrive at the arrival time at a vehicle dispatch location of a user, which is predicted from a behavior of the user, is disclosed (for example, Japanese Unexamined Patent Application Publication No. 2019-101464 (JP 2019-101464 A)).

### SUMMARY

However, the user who uses the vehicle dispatch may be an undesirable user for the vehicle dispatch, for example, a person who has performed a criminal act or a suspicious behavior in a drunken state. This is because a person who has performed a suspicious behavior may, for example, escape or harm others around the user for escape or self-defense.

One of embodiments of the disclosure is to provide an information processing device, an information processing system, and an information processing method capable of appropriately responding to a user who has performed a suspicious behavior in a vehicle dispatch service.

An aspect of the present disclosure is an information processing device including a control device configured to execute: acquisition of a content of a behavior of a user; determination of whether the behavior of the user satisfies a first condition indicating a sign of movement; and movement of a vehicle to a predetermined location where the user and the vehicle are scheduled to join when the behavior of the user satisfies the first condition. In the information processing device, the control device is configured to execute, when the behavior of the user satisfies the first condition and satisfies a second condition indicating a suspicious behavior, control to obstruct realization of movement desired by the user for the vehicle.

Another aspect of the present disclosure is an information processing system including a control device configured to execute: acquisition of a content of a behavior of a user; determination of whether the behavior of the user satisfies a first condition indicating a sign of movement; and movement of a vehicle to a predetermined location where the user and the vehicle are scheduled to join when the behavior of the user satisfies the first condition. In the information processing system, the control device is configured to execute, when the behavior of the user satisfies the first condition and satisfies a second condition indicating a suspicious behavior, control to obstruct realization of movement desired by the user for the vehicle.

Another aspect of the present disclosure is an information processing method including: acquiring, by a control device, a content of a behavior of a user; determining, by the control device, whether the behavior of the user satisfies a first condition indicating a sign of movement; and moving, by the control device, a vehicle to a predetermined location where the user and the vehicle are scheduled to join when the behavior of the user satisfies the first condition. When the behavior of the user satisfies the first condition and satisfies a second condition indicating a suspicious behavior, control to obstruct realization of movement desired by the user is executed by the control device for the vehicle.

According to the present disclosure, it is possible to take an appropriate response to a user who has performed a suspicious behavior in the vehicle dispatch service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a configuration of a vehicle dispatch system according to a first embodiment;

FIG. 2 is a diagram showing an example of a hardware configuration of a center server according to the first embodiment;

FIG. 3 is a diagram showing an example of a functional configuration of the center server;

FIG. 4 is an example of a flowchart of a vehicle dispatch control process executed by the center server; and

FIG. 5 is an example of a flowchart of a vehicle dispatch response determination process executed by the center server.

### DETAILED DESCRIPTION OF EMBODIMENTS

An aspect of the present disclosure is an information processing device including a control device that executes: acquisition of a content of a behavior of a user; determination of whether the behavior of the user satisfies a first condition indicating a sign of movement; and movement of a vehicle to a predetermined location where the user and the vehicle are scheduled to join when the behavior of the user satisfies the first condition. The control device executes, when the behavior of the user satisfies the first condition and satisfies a second condition indicating a suspicious behavior, control to obstruct realization of movement desired by the user for the vehicle.

The information processing device is, for example, a server. The content of the behavior of the user is acquired from, for example, an image or a video captured by a camera installed in and/or in the vicinity of a predetermined building. The behavior of the user indicating the sign of movement indicated by the first condition is, for example, passing through an exit of the predetermined building or making a payment in the predetermined building. The suspicious behavior indicated by the second condition is, for example, a criminal behavior, or a behavior seen in a drunken state.

The control to obstruct realization of movement desired by the user may include, for example, cancellation of movement of the vehicle to the predetermined location, refusal of boarding of the user to the vehicle, change of a destination of the vehicle to a location different from a destination desired by the user, or confinement of the user in the vehicle. Further, the control device may be configured to select a vehicle to be dispatched from a vehicle other than the type of vehicle that is expected to be shared by a plurality of users.

Further, the control device may be configured to, when the behavior of the user corresponds to any criminal act as the second condition, determine a content of the control executed to the vehicle in accordance with a content of the criminal act to which the behavior of the user corresponds.

According to one aspect of the present disclosure, when there is a sign of movement of a suspicious person, the movement of the suspicious person is obstructed.

Therefore, it is possible to suppress escape of the suspicious person and spread of damage to surrounding people, or enhance a possibility of capturing the suspicious person.

Hereinafter, embodiments of the present disclosure will be described with reference to the drawings. The configurations of the following embodiments are illustrative, and the present disclosure is not limited to the configurations of the embodiments.

First Embodiment

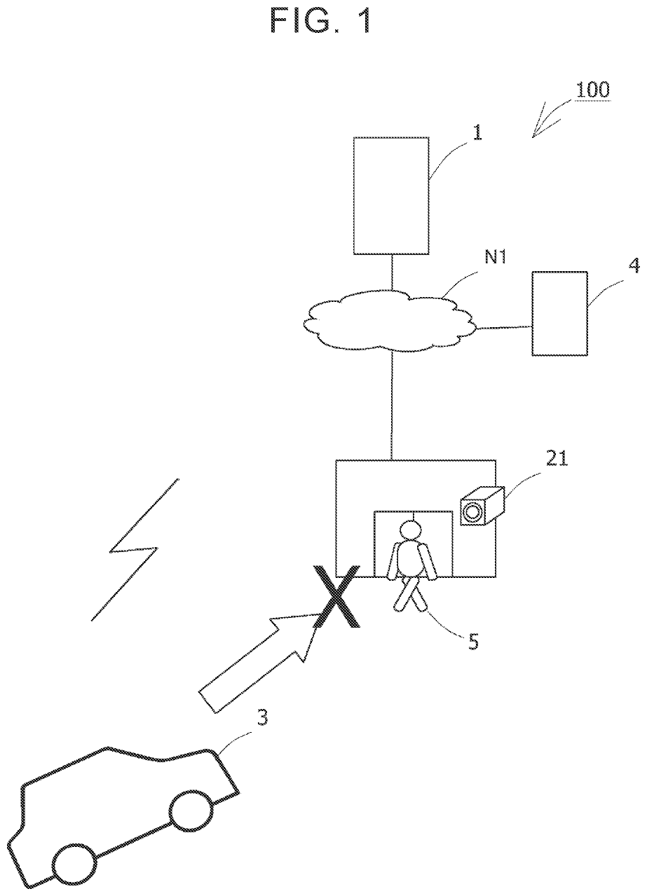

FIG. 1 is a diagram showing an example of a configuration of a vehicle dispatch system 100 (information processing system) according to a first embodiment. The vehicle dispatch system 100 includes a center server 1, a store 2, and a vehicle 3. The vehicle dispatch system 100 is a system that provides a vehicle dispatch service that dispatches the vehicle 3 to a user who is leaving the store 2.

A plurality of cameras 21 is installed inside the store 2 and a plurality of cameras 21 is installed outside the store 2 so as to include the doorway within an imaging range. However, in FIG. 1, only one camera 21 is shown for the sake of simplicity.

The vehicle dispatch system 100 may include a plurality of the vehicles 3. However, in FIG. 1, only one vehicle 3 is shown for the sake of simplicity. The vehicle 3 is, for example, a vehicle that one group of users is on board, such as a passenger vehicle, and a vehicle that a plurality of groups of users can be on board together, such as a bus or a wagon. Hereinafter, the vehicle that one group of users is on board, such as a passenger vehicle, will be referred to as an individual vehicle, and the vehicle that the groups of users can be on board together, such as a bus or a wagon, will be referred to as a shared vehicle. The group of users is, for example, composed of one person or a plurality of people who act together.

The vehicle 3 is, for example, a vehicle that travels by driving by a driver, or a vehicle that can autonomously travel without operations of the driver. When the vehicle 3 is a vehicle that travels by driving by the driver, for example, the vehicle 3 is equipped with an in-vehicle device having a communication function, and an instruction can be issued to the driver through the in-vehicle device. When the vehicle 3 is a vehicle capable of autonomous driving, the vehicle 3 is provided with a control device, and the vehicle 3 can be controlled by issuing an instruction to the control device. Hereinafter, communication regarding the vehicle 3 is performed via a device that has a communication function and is mounted on the vehicle 3. However, for convenience, the description will be made with a focus on the vehicle 3 as “an instruction is transmitted to the vehicle 3”.

The center server 1, the camera 21, and the vehicle 3 are connected to a network N1. The network N1 is, for example, the Internet. However, the network N1 is not limited to the Internet.

The camera 21 captures an image at a predetermined cycle and transmits the captured image to the center server 1. The center server 1 executes image recognition processing on the image captured by the camera 21 and detects a sign that the user leaves the store 2. The sign that the user leaves the store 2 includes, for example, events that the user makes a payment and that the user exits the store 2 through the doorway of the store 2. The sign that the user leaves the store 2 is not limited to the above.

When the center server 1 detects the sign that the user leaves the store 2 from the image captured by the camera 21, the center server 1 instructs the vehicle 3 to travel to a predetermined location of the store 2. The location of the store 2 to which the vehicle 3 is dispatched is, for example, the doorway of the store 2, a boarding position dedicated to the vehicle 3 and installed near the doorway of the store 2, a bus platform, or a taxi platform. The locations above are examples of locations where the user leaving the store 2 and the vehicle 3 are scheduled to join. The vehicle 3 can be dispatched at the timing when the user leaves the store 2 in a manner such that the vehicle 3 travels to the location instructed by the center server 1. When the user gets on the vehicle 3, the vehicle 3 may travel to the destination specified by the user. When the vehicle 3 is a shared vehicle such as a bus, the vehicle 3 may move to a predetermined destination designated by the center server 1.

In the first embodiment, the center server 1 executes, for the vehicle 3, control to obstruct movement of a user 5 who performs a suspicious behavior when the center server 1 detects a sign that the user 5 leaves the store 2 based on the image captured by the camera 21. The suspicious behavior is, for example, a criminal behavior. More specifically, the suspicious behavior includes, for example, shoplifting of products in the store 2, damage to the products or equipment in the store 2, and violence against other users in the store 2. The control to obstruct movement of the user 5 includes, for example, canceling dispatch of the vehicle 3 and causing the user 5 to stay, changing the destination of the vehicle 3 to a police station and transporting the user 5 to the police, and confining the user 5 in the vehicle 3 to help the police capture the user 5 in the vehicle 3 while taking a prevention measure against damage to other users. In addition, the suspicious behavior is not limited to a criminal behavior, and includes, for example, a behavior that tends to occur during a drunken state. The behavior that tends to occur during a drunken state includes, for example, losing a balance while walking, staggering, sitting, and lying down.

According to the first embodiment, when the user 5 who performs a suspicious behavior leaves the store 2, the vehicle 3 is controlled to obstruct the movement of the user 5. Therefore, security of the store 2 can be enhanced.

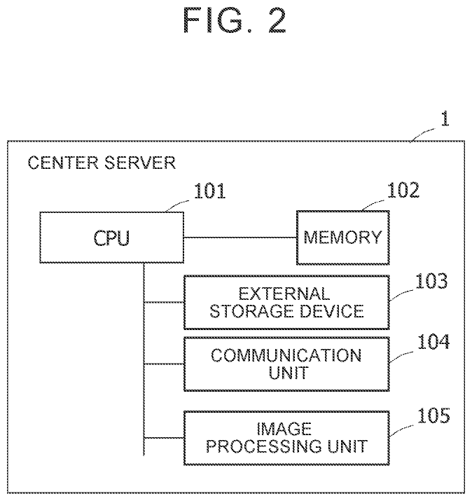

FIG. 2 is a diagram showing an example of a hardware configuration of the center server 1 according to the first embodiment. The center server 1 includes a central processing unit (CPU) 101, a memory 102, an external storage device 103, a communication unit 104, and an image processing unit 105 as hardware configurations. The memory 102 and the external storage device 103 are computer-readable recording media. The center server 1 is an example of the “information processing device”.

The external storage device 103 stores various programs and data used by the CPU 101 when the CPU 101 executes each program. The external storage device 103 is, for example, an erasable programmable ROM (EPROM) and/or a hard disk drive (HDD). The program stored in the external storage device 103 includes, for example, an operating system (OS), a control program of the vehicle dispatch system 100, and various other application programs. The control program of the vehicle dispatch system 100 is a program for controlling the dispatch of the vehicle 3 in the vehicle dispatch system 100.

The memory 102 is a storage device that provides the CPU 101 with a storage area and a work area for loading the program stored in the external storage device 103, and that is used as a buffer. The memory 102 includes, for example, a semiconductor memory such as a read-only memory (ROM) and a random access memory (RAM).

The CPU 101 executes various processes by loading the OS and various application programs stored in the external storage device 103 into the memory 102 and executing the OS and the various application programs. The number of CPUs 101 is not limited to one, and a plurality of the CPUs 101 may be provided. The CPU 101 is an example of a “control device”.

The communication unit 104 is an interface for inputting and outputting information to and from the network. The communication unit 104 performs a mobile communication method such as long term evolution (LTE), LTE-advanced, and the fifth generation (5G), or WiFi communication, and connects to a public network such as the Internet.

The image processing unit 105 is, for example, a processor dedicated to image analysis. The image processing unit 105 executes predetermined recognition processing on the input image and outputs the recognition result to the CPU 101. Note that, the hardware configuration of the center server 1 is not limited to that shown in FIG. 2.

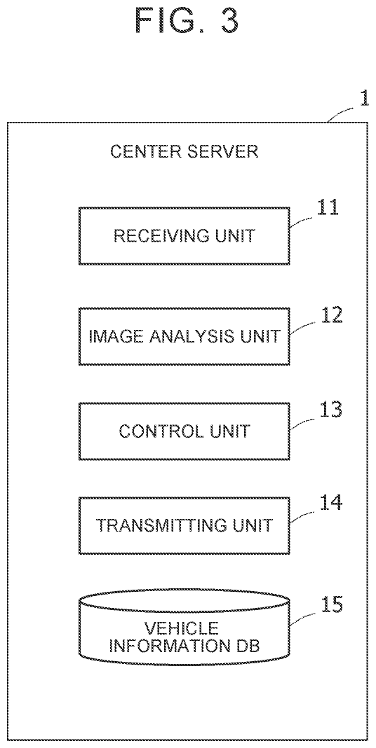

FIG. 3 is a diagram showing an example of a functional configuration of the center server 1. The center server 1 includes a receiving unit 11, an image analysis unit 12, a control unit 13, a transmitting unit 14, and a vehicle information database (DB) 15 as functional components. The receiving unit 11, the control unit 13, and the transmitting unit 14 are achieved in a manner such that the CPU 101 executes a predetermined program.

The receiving unit 11 receives the captured images from the camera 21 at a predetermined cycle through the network N1. The received captured images are output to the image analysis unit 12. The transmitting unit 14 transmits the information input from the control unit 13 to the vehicle 3 through the network N1.

The image analysis unit 12 is a functional component corresponding to the image processing unit 105. The image analysis unit 12 executes image recognition processing on the image captured by the camera 21, and detects presence of a user who satisfies a leaving sign condition indicating the sign that the user leaves the store 2, and presence of a user who satisfies a suspiciousness specification condition for specifying a suspicious behavior. The image analysis unit 12 outputs the detection result to the control unit 13.

The leaving sign condition includes one or more of events that the user passes through the cash register for making a payment, the user approaches the doorway in a leaving direction from the store 2, and the user passes through the doorway in the leaving direction, for example. The leaving sign condition is an example of a “first condition”.

The suspiciousness specification condition includes events that the user puts the product in the store 2 into a personal bag at the sales floor, the user damages the product or equipment in the store 2, and the user violently attacks surrounding people in the store 2. The detection of the behavior that the user puts the products in the store 2 into a personal bag at the sales floor indicates a possibility that shoplifting as a crime occurs. The detection of behavior that the user damages the product or equipment in the store 2 indicates a possibility that property damage as a crime occurs. The detection of the behavior that the user violently attacks surrounding people in the store 2 indicates a possibility that an assault or an injury case as a crime occurs. The suspiciousness specification condition is an example of a “second condition”.

The leaving sign condition and the suspiciousness specification condition are not limited to the above. Further, a method of detecting the behavior of the user corresponding to the leaving sign condition and the suspiciousness specification condition by the image recognition processing is not limited to a specific method.

The control unit 13 executes vehicle dispatch control for the user who leaves the store 2. Specifically, when the control unit 13 receives the detection result indicating presence of the user satisfying the leaving sign condition from the image analysis unit 12, the control unit 13 determines the vehicle 3 to be dispatched to the user with reference to the vehicle information DB 15. For example, the control unit 13 may dispatch a plurality of individual vehicles to a predetermined location regardless of the number of users whose behavior that matches the leaving sign condition has been detected. For example, when the number of users whose behavior that matches the leaving sign condition has been detected is larger than the capacity of the individual vehicle, the control unit 13 may select a shared vehicle and dispatch the shared vehicle.

The destination of the dispatched vehicle 3 can be specified by the user, for example, in the case of the individual vehicle. When the shared vehicle is dispatched, the control unit 13 may set the destination to, for example, a landmark such as the nearest station of the store 2.

When the image analysis unit 12 receives the detection result indicating presence of the user satisfying the leaving sign condition and the detection result indicating that the user is a user satisfying the suspiciousness specification condition, the control unit 13 executes control for the vehicle 3 in accordance with the content of the suspicious behavior. The control for the vehicle 3 when the suspiciousness specification condition is satisfied is an example of “control to obstruct realization of movement desired by the user”.

For example, when the content of the suspicious behavior is a behavior that tends to occur in a drunken state, the control unit 13 may transmit an instruction to the vehicle 3 to refuse boarding of the drunken user when the dispatched vehicle is a shared vehicle. Alternatively, when the content of the suspicious behavior is a behavior that tends to occur in a drunken state, the control unit 13 may dispatch an individual vehicle that the drunken user is to board.

For example, when the content of the suspicious behavior is a behavior related to a crime, the control unit 13 may perform processing according to a heinous level of the crime. The heinous level of a crime is hereinafter referred to as a crime level.

In the first embodiment, for example, three levels of high, medium, and low are used as the crime levels. Crimes classified as the crime level “high” are, for example, injuries, assaults, and murders. A crime classified as the crime level “medium” is, for example, property damage. A crime classified as the crime level “low” is, for example, shoplifting.

When the detected suspicious behavior is a criminal act corresponding to the crime level “high”, the control unit 13 instructs the vehicle 3 to change the destination of the dispatched vehicle 3 to the police station, for example. When the detected suspicious behavior is a criminal act corresponding to the crime level “medium”, the control unit 13 instructs the vehicle 3 to confine the user in the dispatched vehicle 3, for example. When the detected suspicious behavior is a criminal act corresponding to the crime level “low”, the control unit 13 instructs the vehicle 3 to cancel the dispatch of the vehicle 3, for example.

Note that the setting of a crime classified into each crime level described above and the content of control for the vehicle 3 corresponding to each crime level are merely examples, and are not limited to the above. The setting and the content of the control can be set by the administrator of the vehicle dispatch system 100, as appropriate.

The control unit 13 instructs the vehicle 3 to travel to a predetermined location of the store 2 through the transmitting unit 14. The predetermined location of the store 2 to which the vehicle 3 is dispatched is, for example, the doorway of the store 2, a boarding position dedicated to the vehicle 3 and installed near the doorway of the store 2, the bus platform, or the taxi platform. The predetermined location when the vehicle 3 is dispatched may be the same place regardless of which vehicle is dispatched, and may be determined each time the vehicle is dispatched in accordance with a behavior or attribute of the user, the type of vehicle, or the like.

The vehicle information DB 15 stores the information related to the vehicle 3. The vehicle information DB 15 is created in the storage area of the external storage device 103, for example. The information stored in the vehicle information DB 15 includes, for example, identification information of the vehicle 3, the type of the vehicle 3, the capacity, and information indicating whether in service or on standby. The type of the vehicle 3 is, for example, a type related to the shape of a vehicle body such as a sedan, a wagon, or a bus. The control unit 13 determines whether the vehicle 3 is an individual vehicle or a shared vehicle depending on the type of the vehicle 3.

The center server 1 can also use a social networking service (SNS) server 4 as an information source. For example, the center server 1 may monitor the SNS managed by the SNS server 4, and when a post including an image captured by a camera to which the location information of the store 2 is added is posted, the center server 1 may acquire the captured image from the SNS server 4 and execute image recognition. In this case, the control unit 13 monitors the SNS server 4, and the image analysis unit 12 executes the image recognition processing of the acquired image. The process after the image recognition processing is the same as the case where the image captured by the camera 21 is used as an information source.

Processing Flow

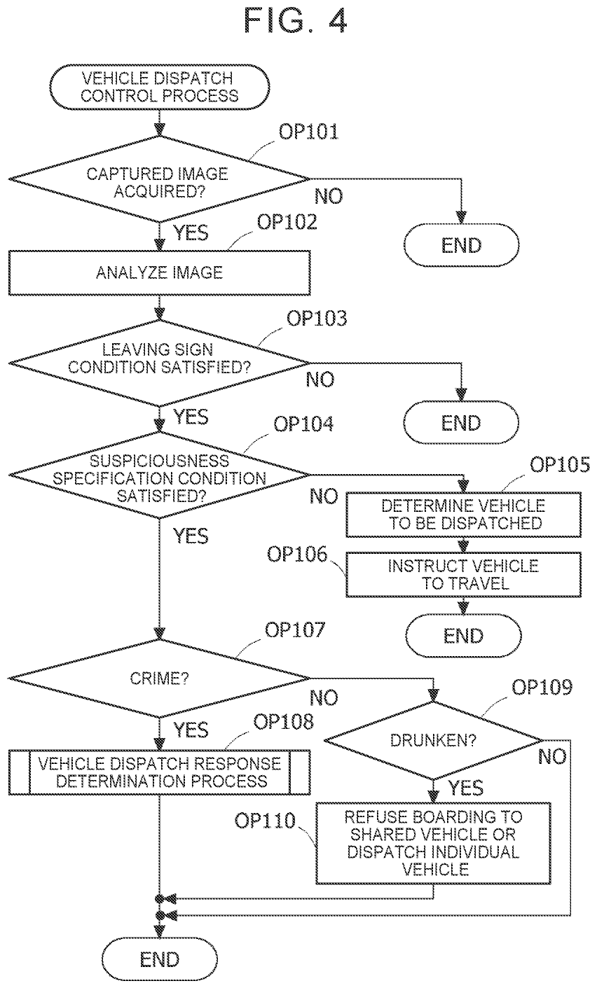

FIG. 4 is an example of a flowchart of a vehicle dispatch control process executed by the center server 1. The process shown in FIG. 4 is repeatedly executed at a predetermined cycle. The process shown in FIG. 4 is mainly executed by the CPU 101. However, for convenience, description will be made with a main focus on the functional components. The same applies to the following flowcharts.

In OP101, the control unit 13 determines whether the captured image is acquired. The captured image is acquired by, for example, inputting the captured image from the camera 21 in the store 2 via the receiving unit 11, or by detecting a post including the captured image having the location information of the store 2 published to a predetermined SNS and acquiring the captured image from the SNS server 4.

When the captured image is acquired (OP101: YES), the process proceeds to OP102. When the captured image is not acquired (OP101: NO), the process shown in FIG. 4 ends.

In OP102, the image analysis unit 12 executes the image recognition processing on the captured image, and the control unit 13 acquires the result of the image recognition processing from the image analysis unit 12.

In OP103, the control unit 13 determines whether presence of a user who performs a behavior satisfying the leaving sign condition is detected as a result of the image recognition processing. When the presence of the user who performs a behavior satisfying the leaving sign condition is detected (OP103: YES), the process proceeds to OP104. When the presence of the user who performs a behavior satisfying the leaving sign condition is not detected (OP103: NO), the process shown in FIG. 4 ends.

In OP104, the control unit 13 determines whether a behavior satisfying the suspiciousness specification condition is detected for the user who performs the behavior satisfying the leaving sign condition. When the behavior satisfying the suspiciousness specification condition is detected for the user who performs the behavior satisfying the leaving sign condition (OP104: YES), the process proceeds to OP107. When the behavior satisfying the suspiciousness specification condition is not detected for the user who performs the behavior satisfying the leaving sign condition (OP104: NO), the process proceeds to OP105.

In OP105, for example, the control unit 13 refers to the vehicle information DB 15 and determines the vehicle 3 to be dispatched to the user whose behavior satisfying the leaving sign condition has been detected. The vehicle 3 to be dispatched to the user may be determined based on, for example, the number of users whose behaviors satisfying the leaving sign condition have been detected and the members constituting the group. The number of users and the members constituting the group are acquired by, for example, the image recognition processing executed by the image analysis unit 12. In OP106, the control unit 13 transmits, to the vehicle 3, the instruction to travel to a predetermined location of the store 2 through the transmitting unit 14. After that, the process shown in FIG. 4 ends.

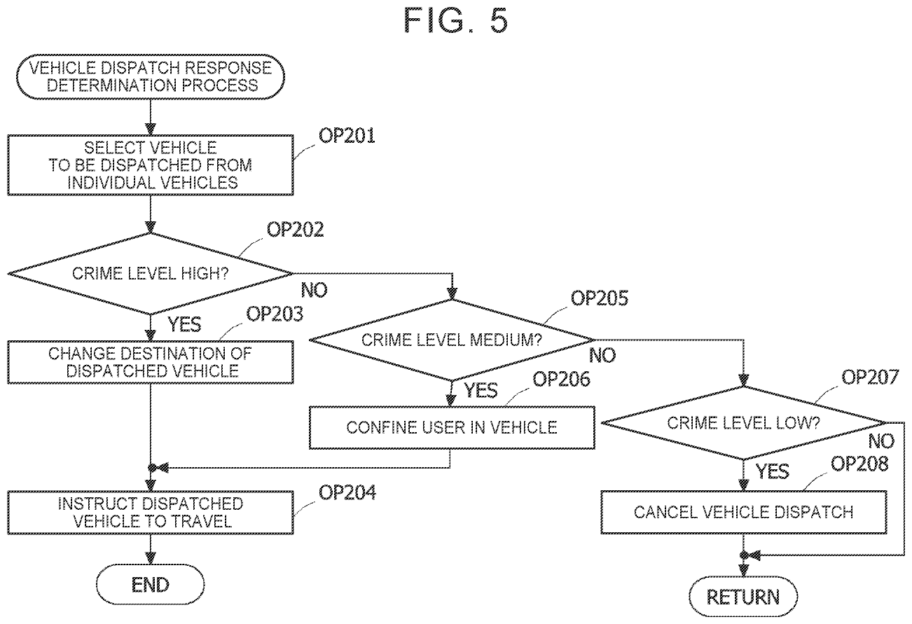

In OP107, the control unit 13 determines whether the content of the behavior of the user whose behavior satisfying the suspiciousness specification condition has been detected is a behavior related to a crime. When the content of the behavior of the user whose behavior satisfying the suspiciousness specification condition has been detected is a behavior related to crime (OP107: YES), the process proceeds to OP108. In OP108, a vehicle dispatch response determination process for determining control for the vehicle 3 corresponding to the crime level of the behavior of the user whose behavior satisfying the suspiciousness specification condition has been detected is executed. The detail of the vehicle dispatch response determination process will be described in detail in FIG. 5. When the vehicle dispatch response determination process in OP108 ends, the process shown in FIG. 4 ends.

In OP109, the control unit 13 determines whether the content of the behavior of the user whose behavior satisfying the suspiciousness specification condition has been detected is a behavior that tends to occur in a drunken state. When the content of the behavior of the user whose behavior satisfying the suspiciousness specification condition has been detected is a behavior that tends to occur in a drunken state (OP109: YES), the process proceeds to OP110. When the content of the behavior of the user whose behavior satisfying the suspiciousness specification condition has been detected is not a behavior that tends to occur in a drunken state (OP109: NO), the process shown in FIG. 4 ends.

In OP110, when a shared vehicle is dispatched, the control unit 13 instructs the vehicle 3 to travel to the predetermined location of the store 2 and to refuse boarding of the user. When an individual vehicle is dispatched, the control unit 13 transmits an instruction to the vehicle 3 to travel to the predetermined location of the store 2. After that, the process shown in FIG. 4 ends.

FIG. 5 is an example of a flowchart of the vehicle dispatch response determination process executed by the center server 1. The process shown in FIG. 5 is the process executed in OP108 shown in FIG. 4.

In OP201, the control unit 13 selects the vehicle 3 to be dispatched to the user whose behavior satisfying the leaving sign condition has been detected from the individual vehicles.

In OP202, the control unit 13 determines whether a behavior performed by the user whose behavior satisfying the leaving sign condition has been detected is a behavior corresponding to a crime classified as the crime level “high” based on the analysis result from the image analysis unit 12. When the behavior performed by the user whose behavior satisfying the leaving sign condition has been detected is a behavior corresponding to a crime classified as the crime level “high” (OP202: YES), the process proceeds to OP203. When the behavior performed by the user whose behavior satisfying the leaving sign condition has been detected is not a behavior corresponding to a crime classified as the crime level “high” (OP202: NO), the process proceeds to OP205.

In OP203, the control unit 13 instructs the dispatched vehicle 3 to change the destination of the vehicle 3 to, for example, the nearest police station. Note that, when the user can specify the destination of the dispatched vehicle 3, in OP203, the control unit 13 instructs the vehicle 3 to invalidate designation of the destination by the user and forcibly set the destination as, for example, the police station. This makes it possible to quickly take the user who has committed a highly heinous criminal act to the police station. Moreover, the user can be isolated from the surrounding people and moved to another place. Therefore, the safety of the surrounding people can be protected.

In OP204, the control unit 13 transmits, to the vehicle 3, an instruction to travel to the predetermined location of the store 2. After that, the process shown in FIG. 5 ends, and the process shown in FIG. 4 also ends.

In OP205, the control unit 13 determines whether a behavior performed by the user whose behavior satisfying the leaving sign condition has been detected is a behavior corresponding to a crime classified as the crime level “medium” based on the analysis result from the image analysis unit 12. When the behavior performed by the user whose behavior satisfying the leaving sign condition has been detected is a behavior corresponding to a crime classified as the crime level “medium” (OP205: YES), the process proceeds to OP206. When the behavior performed by the user whose behavior satisfying the leaving sign condition has been detected is not a behavior corresponding to a crime classified as the crime level “medium” (OP205: NO), the process proceeds to OP207.

In OP206, the control unit 13 instructs the dispatched vehicle 3 to stay in the location without moving when the user gets on the vehicle and confine the user in the vehicle 3. With the processing above, it is possible to suppress the user from causing harm to the surrounding people, and it is also possible to wait for the arrival of the police relatively safely.

After that, the process proceeds to OP204.

In OP207, the control unit 13 determines whether a behavior performed by the user whose behavior satisfying the leaving sign condition has been detected is a behavior corresponding to a crime classified as the crime level “low” based on the analysis result from the image analysis unit 12. When the behavior performed by the user whose behavior satisfying the leaving sign condition has been detected is a behavior corresponding to a crime classified as the crime level “low” (OP207: YES), the process proceeds to OP208. When the behavior performed by the user whose behavior satisfying the leaving sign condition has been detected is not a behavior corresponding to a crime classified as the crime level “low” (OP207: NO), the process shown in FIG. 5 ends, and the process shown in FIG. 4 also ends.

In OP208, the control unit 13 determines that the vehicle dispatch to the corresponding user is cancelled. With the processing above, the vehicle 3 is not dispatched to the corresponding user, and the corresponding user can be caused to stay. It is more likely that the user can be captured while the user is caused to stay in the store 2. After that, the process shown in FIG. 5 ends, and the process shown in FIG. 4 also ends.

Further, in OP203 and OP206, along with the instruction, information related to the corresponding user is also transmitted to the vehicle 3. The information related to the corresponding user to be transmitted to the vehicle 3 is, for example, a face image of the corresponding user acquired from the captured image. With the process above, the vehicle 3 identifies that the boarding user is the corresponding user based on the information related to the corresponding user, and can execute an instruction from the center server 1 such as a change of the destination or confinement of the user. The processes shown in FIGS. 4 and 5 are examples, and the processes executed by the center server 1 are not limited thereto.

Action Effect of First Embodiment

In the first embodiment, in the vehicle dispatch system 100 that dispatches a vehicle to the user when the sign that the user leaves the store 2 is detected, the vehicle 3 is controlled, to the user whose suspicious behavior has been detected, so as to obstruct movement of the user. With the configuration above, it is possible to take preventive measure against an escape of the user whose suspicious behavior has been detected and to isolate the user from the surrounding people, thereby improving the security.

Other Embodiments

The above-described embodiment is merely an example, and the present disclosure may be appropriately modified and implemented without departing from the scope thereof.

In the first embodiment, the vehicle dispatch system 100 for the store 2 has been described as a premise. However, the technique described in the first embodiment is not limited to the store and can be applied to various facilities. In addition, the technique described in the first embodiment can be applied within a specified range regardless of indoors or outdoors. For example, the technique can be applied to outdoor shopping malls, amusement parks, and tourist facilities. The leaving sign condition can be changed depending on the characteristics of the facility to which the technique is applied.

In the first embodiment, the center server 1 executes the image recognition processing on the captured image. However, a device different from the center server 1 may execute the image recognition processing and transmit the result of the image recognition processing to the center server 1. The device that executes the image recognition processing is, for example, a server installed in the store 2, or an external dedicated server.

In the first embodiment, the condition that the user is a wanted criminal may be added to the suspiciousness specification condition. In this case, when the wanted criminal is detected by the image recognition processing executed on the captured image, processes such as the process to cancel the vehicle dispatch, the process to change the destination, or the process to confine the user in the vehicle may be executed as described in the first embodiment.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device, comprising a control device configured to execute:
acquisition of a content of a behavior of a user;
determination of whether the behavior of the user satisfies a first condition indicating a sign of movement; and
movement of a vehicle to a predetermined location where the user and the vehicle are scheduled to join when the behavior of the user satisfies the first condition, wherein the control device is configured to execute, when the behavior of the user satisfies the first condition and satisfies a second condition indicating a suspicious behavior, control to obstruct realization of movement desired by the user for the vehicle.

2. The information processing device according to claim 1, wherein the control device cancels, as the control, the movement of the vehicle to the predetermined location.

3. The information processing device according to claim 1, wherein the control device causes the vehicle to refuse, as the control, boarding of the user.

4. The information processing device according to claim 1, wherein the control device changes, as the control, a destination of the vehicle to a location different from a destination desired by the user.

5. The information processing device according to claim 1, wherein the control device causes the vehicle to confine, as the control, the user in the vehicle.

6. The information processing device according to claim 1, wherein the control device is configured to, when the behavior of the user corresponds to any criminal act as the second condition, determine a content of the control in accordance with a content of the criminal act to which the behavior of the user corresponds.

7. The information processing device according to claim 1, wherein the control device is configured to, when the behavior of the user satisfies the first condition and satisfies the second condition, select the vehicle from a vehicle other than a type of vehicle that is expected to be shared by a plurality of users.

8. An information processing system, comprising a control device configured to execute:
acquisition of a content of a behavior of a user;
determination of whether the behavior of the user satisfies a first condition indicating a sign of movement; and
movement of a vehicle to a predetermined location where the user and the vehicle are scheduled to join when the behavior of the user satisfies the first condition, wherein the control device is configured to execute, when the behavior of the user satisfies the first condition and satisfies a second condition indicating a suspicious behavior, control to obstruct realization of movement desired by the user for the vehicle.

9. The information processing system according to claim 8, wherein the control device cancels, as the control, the movement of the vehicle to the predetermined location.

10. The information processing system according to claim 8, wherein the control device causes the vehicle to refuse, as the control, boarding of the user.

11. The information processing system according to claim 8, wherein the control device changes, as the control, a destination of the vehicle to a location different from a destination desired by the user.

12. The information processing system according to claim 8, wherein the control device causes the vehicle to confine, as the control, the user in the vehicle.

13. The information processing system according to claim 8, wherein the control device is configured to, when the behavior of the user corresponds to any criminal act as the second condition, determine a content of the control in accordance with a content of the criminal act to which the behavior of the user corresponds.

14. The information processing system according to claim 8, wherein the control device is configured to, when the behavior of the user satisfies the first condition and satisfies the second condition, select the vehicle from a vehicle other than a type of vehicle that is expected to be shared by a plurality of users.

15. An information processing method comprising:
acquiring, by a control device, a content of a behavior of a user;
determining, by the control device, whether the behavior of the user satisfies a first condition indicating a sign of movement; and
moving, by the control device, a vehicle to a predetermined location where the user and the vehicle are scheduled to join when the behavior of the user satisfies the first condition, wherein when the behavior of the user satisfies the first condition and satisfies a second condition indicating a suspicious behavior, control to obstruct realization of movement desired by the user is executed by the control device for the vehicle.

16. The information processing method according to claim 15, wherein movement of the vehicle to the predetermined location is canceled as the control.

17. The information processing method according to claim 15, wherein the vehicle is caused to refuse, as the control, boarding of the user.

18. The information processing method according to claim 15, wherein a destination of the vehicle is changed, as the control, to a location different from a destination desired by the user.

19. The information processing method according to claim 15, wherein the user is confined in the vehicle as the control.

20. The information processing method according to claim 15, wherein when the behavior of the user corresponds to any criminal act as the second condition, a content of the control is determined by the control device in accordance with a content of the criminal act to which the behavior of the user corresponds.
